(19) United States
(12) Patent Application Publication
(10) Pub. No.: US 2026/0150077 A1
(43) Pub. Date: May 28, 2026

(54) TERMINAL POSITIONING METHOD AND APPARATUS BASED ON AI MODEL

(71) Applicant: Beijing Xiaomi Mobile Software Co., Ltd., Beijing (CN)

(72) Inventors: Qin MU, Beijing (CN); Zhongyuan ZHAO, Beijing (CN); Huixuan ZHOU, Beijing (CN)

(73) Assignee: Beijing Xiaomi Mobile Software Co., Ltd., Beijing (CN)

(21) Appl. No.: 19/122,493

(22) PCT Filed: Oct. 19, 2022
(86) PCT No.: PCT/CN2022/126287

§ 371 Date: Apr. 18, 2025

(51) Int. Cl. H04W 64/00; G01S 5/00; G01S 5/02

(52) U.S. Cl. CPC H04W 64/00; G01S 5/0036; G01S 5/02528

(57) ABSTRACT

Provided in the present disclosure are a terminal positioning method and apparatus based on an AI model, which method and apparatus can be applied to the technical field of communications. The method comprises: inputting a channel impulse response into a first part module, which is deployed at a terminal side, of an AI model, such that processing is performed to obtain quantized bit information; and sending the quantized bit information to a second part module, which is at a network side, of the AI model, wherein the first part module, which is at the terminal side, of the AI model assists the AI model in performing terminal positioning, such that the input amount of channel impulse responses to the network side is reduced, thereby reducing the occupation of transmission resources at the network side.

### CROSS REFERENCE TO RELATED APPLICATIONS

This application is a US National Phase of a PCT Application No. PCT/CN 2022/126287 filed on Oct. 19, 2022, the entire contents of which are incorporated herein by reference in their entireties.

### TECHNICAL FIELD

The present disclosure relates to the field of communication technology, particularly to terminal positioning methods and apparatuses based on an AI model.

### BACKGROUND

In related arts, such as in industrial scenarios, the requirement for positioning accuracy is very high. After the artificial intelligence (AI) model is trained, the trained AI model can be deployed in the network side or the terminal side for inference. For the inference, the input to the AI model is still the measurement result, and based on the measurement result, the AI model will output the corresponding position of the terminal.

In a current positioning solution, a channel impulse response is inputted to the AI model, where the input generally has a large dimension. The terminal needs to obtain the channel impulse response based on the measurement quantity, quantize the channel impulse response, and feedback the quantized channel impulse response to the network. In this scenario, the amount of feedback is relatively large, which occupies a lot of transmission resources.

### SUMMARY

In the first aspect, the embodiments of the present disclosure provide a terminal positioning method based on an AI model, performed by a terminal side, where the AI model includes a first part module and a second part module, the first part module is deployed in the terminal side, and the method includes:
inputting a channel impulse response into the first part module for processing, to obtain quantized bit information; and
transmitting the quantized bit information to a network side.

In an embodiment, the first part module includes a quantization module, and inputting the channel impulse response into the first part module for processing, to obtain the quantized bit information includes:
based on the quantization module, quantizing the inputted channel impulse response to obtain the quantized bit information.

In an embodiment, the first part module includes a compression module and a quantization module, and inputting the channel impulse response into the first part module for processing, to obtain the quantized bit information includes:
based on the compression module, compressing the channel impulse response to obtain a compressed channel impulse response; and
based on the quantization module, quantize the compressed channel impulse response to obtain the quantized bit information.

In an embodiment, the first part module and the second part module in the AI model are obtained by joint training.

In the second aspect, the embodiments of the present disclosure provide a terminal positioning method based on an AI model, performed by a network side, where the AI model includes a first part module and a second part module, the second part module is deployed in the network side, and the method includes:
receiving quantized bit information transmitted by a terminal side; and
inputting the quantized bit information into the second part module for processing to obtain positioning information of a terminal.

In an embodiment, the second part module includes a dequantization module, and inputting the quantized bit information into the second part module for processing to obtain the positioning information of the terminal includes:
based on the dequantization module, dequantizing the quantized bit information to obtain the positioning information of the terminal.

In an embodiment, the second part module includes a dequantization module and a decompression module, and inputting the quantized bit information into the second part module for processing to obtain the positioning information of the terminal includes:
based on the dequantization module, dequantize the quantized bit information to obtain a compressed channel impulse response; and
based on the decompression module, process the compressed channel impulse response to obtain the positioning information of the terminal.

In an embodiment, the first part module and the second part module in the AI model are obtained by joint training.

In an embodiment, the positioning information refers to positioning coordinates or parameters required for positioning.

In an embodiment, the parameter required for positioning is any one of the following:
signal arrival time, signal arrival angle, non-line-of-sight (NLOS) information, or line-of-sight (LOS) information.

In the third aspect, the embodiments of the present disclosure provide a terminal positioning apparatus based on an AI model, applied to a terminal side, where the AI model includes a first part module and a second part module, the first part module is deployed in the terminal side, and the apparatus includes:
a processing unit, configured to input a channel impulse response into the first part module for processing, to obtain quantized bit information; and
a transmitting unit, configured to transmit the quantized bit information to a network side.

In an embodiment, the first part module includes a quantization module,
where the processing unit is further configured to, based on the quantization module, quantize the inputted channel impulse response to obtain the quantized bit information.

In an embodiment, the first part module includes a compression module and a quantization module.

The processing unit is further configured to, based on the compression module, compress the channel impulse response to obtain a compressed channel impulse response; and
based on the quantization module, quantize the compressed channel impulse response to obtain the quantized bit information.

In an embodiment, the first part module and the second part module in the AI model are obtained by joint training.

In the fourth aspect, the embodiments of the present disclosure provide a terminal positioning apparatus based on an AI model, applied to a network side, where the AI model includes a first part module and a second part module, the second part module is deployed in the network side, and the apparatus includes:
a receiving unit, configured to receive quantized bit information transmitted by a terminal side; and
a processing unit, configured to input the quantized bit information into the second part module for processing to obtain positioning information of a terminal.

In an embodiment, the second part module includes a dequantization module, and the processing unit is further configured to dequantize the quantized bit information based on the dequantization module to obtain the positioning information of the terminal.

In an embodiment, the second part module includes a dequantization module and a decompression module. The processing unit is further configured to:
based on the dequantization module, dequantize the quantized bit information to obtain a compressed channel impulse response; and
based on the decompression module, process the compressed channel impulse response to obtain the positioning information of the terminal.

In an embodiment, the first part module and the second part module in the AI model are obtained by joint training.

In an embodiment, the positioning information refers to positioning coordinates or parameters required for positioning.

In an embodiment, the parameter required for positioning is any one of the following:
signal arrival time, signal arrival angle, non-line-of-sight (NLOS) information, or line-of-sight (LOS) information.

In the fifth aspect, the embodiments of the present disclosure provide a computer-readable storage medium storing instructions used for the terminal positioning apparatus based on an AI model described above. When the instructions are executed, the terminal positioning apparatus based on an AI model is caused to perform the method described in the first or second aspect.

In a sixth aspect, the embodiments of the present disclosure further provide a computer program product including a computer program, where when the computer program runs on a computer, the computer executes the method described in the first aspect or the second aspect.

In the seventh aspect, the embodiments of the present disclosure provide a chip system including at least one processor and interface for supporting a communication device to implement the functions involved in the first or second aspect, such as determining or processing at least one of the data or information involved in the above method. In some embodiments, the chip system further includes one or more memories for storing a computer program and data necessary for a communication device. The chip system can be composed of one or more chips or include one or more chips and other discrete devices.

In the eighth aspect, the embodiments of the present disclosure further provide a computer program, where when the computer program runs on a computer, the computer executes the method described in the first aspect or the second aspect.

### BRIEF DESCRIPTION OF DRAWINGS

In order to provide a clearer explanation of technical solutions in the embodiments or background technology of the present disclosure, accompanying drawings used in the embodiments or background technology of the present disclosure will be explained below.

FIG. 1 is a schematic structural diagram of a communication system provided in the embodiments of the present disclosure.

FIG. 2 is a flowchart of a terminal positioning method based on an AI model provided in the embodiments of the present disclosure.

FIG. 3 is a flowchart of another terminal positioning method based on an AI model provided in the embodiments of the present disclosure.

FIG. 4 is a flowchart of another terminal positioning method based on an AI model provided in the embodiments of the present disclosure.

FIG. 5 is a flowchart of another terminal positioning method based on an AI model provided in the embodiments of the present disclosure.

FIG. 6 is a flowchart of another terminal positioning method based on an AI model provided in the embodiments of the present disclosure.

FIG. 7 is a flowchart of another terminal positioning method based on an AI model provided in the embodiments of the present disclosure.

FIG. 8 is a schematic structural diagram of a terminal positioning apparatus based on an AI model provided in the embodiments of the present disclosure.

FIG. 9 is a schematic structural diagram of another terminal positioning apparatus based on an AI model provided in the embodiments of the present disclosure.

FIG. 10 is a schematic structural diagram of a communication device provided in the embodiments of the present disclosure.

FIG. 11 is a schematic structural diagram of a chip provided in the embodiments of the present disclosure.

### DETAILED DESCRIPTION

In order to better understand the terminal positioning methods and apparatuses based on an AI model disclosed in the embodiments of the present disclosure, the following first describes the communication system applicable to the embodiments of the present disclosure.

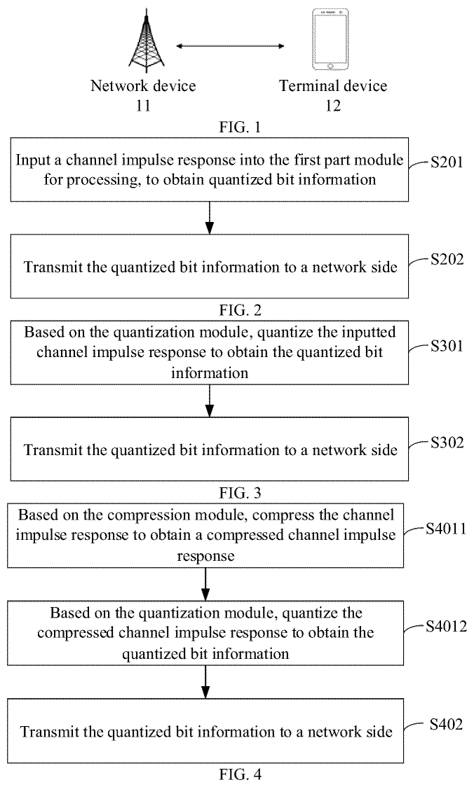

Referring to FIG. 1, FIG. 1 is a schematic structural diagram of a communication system according to embodiments of the present disclosure. The communication system may include but is not limited to one network device and one terminal device. The number and form of devices shown in FIG. 1 are only for example and do not constitute a limitation on the embodiments of the present disclosure. In practical applications, the communication system may include two or more network devices, or two or more terminal devices. The communication system shown in FIG. 1 includes one network device 11 and one terminal device 12 as an example.

It should be noted that the technical solution of the embodiments of the present disclosure can be applied to various communication systems, such as a long term evolution (LTE) system, a 5th generation (5G) mobile communication system, a 5G new radio (NR) system, or other future new mobile communication systems.

The network device 11 in the embodiments of the present disclosure is an entity of the network side for transmitting or receiving signals. For example, the network device 101 can be an evolved NodeB (eNB), a transmission reception point (TRP), a next generation NodeB (gNB) in an NR system, base stations in other future mobile communication systems, or access nodes in wireless fidelity (WiFi) systems. The embodiments of the present disclosure do not limit the specific technology or specific device form adopted by the network device. The network device provided in the embodiments of the present disclosure can be composed of a central unit (CU) and a distributed unit (DU), where the CU can also be referred to as a control unit. The network device (such as a protocol layer of the base station) can be separated by the CU-DU structure, where some functions of the protocol layer are distributed in the CU and centrally controlled, and a part of or all of the remaining functions of the protocol layer are distributed in the DU, where the DU is centrally controlled by the CU.

The terminal device 12 in the embodiments of the present disclosure is an entity for receiving or transmitting signals on the user side, such as a mobile phone. The terminal device can also be referred to as a terminal, a user equipment (UE), a mobile station (MS), or a mobile terminal (MT). The terminal device can include a car, a smart car, a mobile phone, a wearable device, a pad, a computer with a wireless transmission and reception capability, a virtual reality (VR) terminal device, an augmented reality (AR) terminal device, a wireless terminal device in industrial control, a wireless terminal device in self driving, a wireless terminal device in remote medical surgery, a wireless terminal device in smart grid, a wireless terminal device in transportation security, a wireless terminal device in smart city, or a wireless terminal device in smart home, that has a communication capability. The embodiments of the present disclosure do not limit the specific technology or specific device form adopted by the terminal device.

It can be understood that the communication system described in the embodiments of the present disclosure is intended to provide a clearer explanation of the technical solutions in the embodiments of the present disclosure, and does not constitute a limitation on the technical solutions provided in the embodiments of the present disclosure. As those skilled in the art know, with the evolution of the system architecture and the emergence of new business scenarios, the technical solutions provided in the embodiments of the present disclosure are also applicable to similar technical problems.

In related arts, such as in industrial scenarios, the requirement for positioning accuracy is very high. After the artificial intelligence (AI) model is trained, the trained AI model can be deployed in the network side or the terminal side for inference. For the inference, the input to the AI model is still the measurement result, and based on the measurement result, the AI model will output the corresponding position of the terminal. In a current positioning solution, a channel impulse response is inputted to the AI model, where the input generally has a large dimension. The terminal needs to obtain the channel impulse response based on the measurement quantity, quantize the channel impulse response, and feedback the quantized channel impulse response to the network. In this scenario, the amount of feedback is relatively large, which occupies a lot of transmission resources.

Referring to FIG. 2, FIG. 2 is a flowchart of a terminal positioning method based on an AI model provided in the embodiments of the present disclosure. The method is performed by the terminal side. The AI model includes a first part module and a second part module. The first part module is deployed in the terminal side. As shown in FIG. 2, the method may include but is not limited to the following steps S201 and S202.

In step S201, a channel impulse response is inputted into the first part module for processing, to obtain quantized bit information.

In the embodiments of the present disclosure, the AI model includes a first part module and a second part module. The first part module of the AI model is deployed in the terminal side, and the second part module is deployed in the network side.

At the terminal side, the channel impulse response is obtained based on the measurement quantity, and then the channel impulse response is inputted to the first part module in the terminal side to obtain quantized bit information. This processing is executed by the terminal side.

In step S202, the quantized bit information is transmitted to a network side.

The quantized bit information obtained by the terminal side based on the first part module is transmitted to the second part module in the network side, such that the second part module in the network side can obtain the positioning information of the terminal based on the quantized bit information. It can be seen that in the method provided in the present disclosure, the input of the AI model is the channel impulse response of the terminal side, and the output of the AI model is the positioning information of the terminal executed by the network side.

In all embodiments in the present disclosure, the first part module is deployed in the terminal side for compressing the first channel impulse response, and quantizing the compressed first channel impulse response to obtain quantized data of the first channel impulse response. The second part module is deployed in the network side and is used to determine the positioning information of the terminal based on the received quantized data of the first channel impulse response.

In all embodiments in the present disclosure, bit information refers to one or more bits, or data composed of one or more bits; or in other words, bit information is information in the form of bits.

In some embodiments, the positioning information of the terminal includes but is not limited to positioning coordinates or parameters required for determining the terminal positioning.

The channel impulse response is processed through the first part module of the AI model deployed in the terminal side by inputting the channel impulse response into the first part module to obtain quantized bit information. The quantized bit information is then transmitted to the second part module of the AI model in the network side. The first part module of the AI model in the terminal side assists the AI model in terminal positioning, which can reduce the input amount of channel impulse response on the network side and thus reduce the occupation of transmission resources on the network side.

The embodiments of the present disclosure provide another terminal positioning method based on an AI model. FIG. 3 is a flowchart of another terminal positioning method based on an AI model provided in the embodiments of the present disclosure. The method is performed by the terminal side. As shown in FIG. 3, the terminal positioning method based on an AI model may include the following steps S301 and S302.

In step S301, based on the quantization module, the inputted channel impulse response is quantized to obtain the quantized bit information.

In the embodiments of the present disclosure, the AI model includes a first part module and a second part module. The first part module of the AI model is deployed in the terminal side, where the first part module includes a quantization module, and the second part module is deployed in the network side.

At the terminal side, the channel impulse response is obtained based on the measurement quantity, and then inputted into the quantization module of the first part module in the terminal side. Based on the quantization module, the input channel impulse response is quantized to obtain quantized bit information. This process is executed by the terminal side.

In step S302, the quantized bit information is transmitted to a network side.

The quantized bit information obtained based on the first part module in the terminal side is transmitted to the second part module in the network side, such that the second part module in the network side can obtain the positioning information of the terminal based on the quantized bit information. It can be seen that in the method provided in the present disclosure, the input of the AI model is the channel impulse response of the terminal side, and the output of the AI model is the positioning information of the terminal executed by the network side.

In some embodiments, the positioning information of the terminal includes but is not limited to positioning coordinates or parameters required by the terminal.

The channel impulse response is inputted into the quantization module of the first part module of the AI model deployed in the terminal side, and based on the quantization module, the input channel impulse response is quantized to obtain quantized bit information. The quantized bit information is then transmitted to the second part module of the AI model in the network side. The first part module of the AI model in the terminal side assists the AI model in terminal positioning, which can reduce the input amount of channel impulse response on the network side and thus reduce the occupation of transmission resources on the network side.

The embodiments of the present disclosure provide another terminal positioning method based on an AI model. FIG. 4 is a flowchart of another terminal positioning method based on an AI model provided in the embodiments of the present disclosure. The method is performed by the terminal side. As shown in FIG. 4, the terminal positioning method based on an AI model may include the following steps S4011, S4012 and S402.

In step S4011, based on the compression module, the channel impulse response is compressed to obtain a compressed channel impulse response.

In the embodiments of the present disclosure, the AI model includes a first part module and a second part module. The first part module of the AI model is deployed in the terminal side, where the first part module includes a compression module and a quantization module, and the second part module is deployed in the network side.

At the terminal side, the channel impulse response is obtained based on the measurement quantity, and then the channel impulse response is compressed by the compression module to obtain the compressed channel impulse response.

In step S4012, based on the quantization module, the compressed channel impulse response is quantized to obtain the quantized bit information.

The compressed channel impulse response inputted into the quantization module of the first part module in the terminal side. Based on the quantization module, the inputted compressed channel impulse response is quantized to obtain quantized bit information. This process is executed by the terminal side.

In step S402, the quantized bit information is transmitted to a network side.

The quantized bit information obtained based on the first part module in the terminal side is transmitted to the second part module in the network side, such that the second part module in the network side can obtain the positioning information of the terminal based on the quantized bit information. It can be seen that in the method provided in the present disclosure, the input of the AI model is the channel impulse response of the terminal side, and the output of the AI model is the positioning information of the terminal executed by the network side.

In some embodiments, the positioning information of the terminal includes but is not limited to positioning coordinates or parameters required by the terminal.

The channel impulse response is compressed by the first part module of the AI model deployed in the terminal side first based on the compression module of the first part module. The compressed channel impulse response is inputted into the quantization module of the first part module. The input compressed channel impulse response is quantized based on the quantization module to obtain quantized bit information. The quantized bit information is transmitted to the second part module of the AI model in the network side. The compression module and quantization module of the first part module of the AI model in the terminal side assist the AI model in terminal positioning, which further reduces the input amount of channel impulse response on the network side and thereby reduces the occupation of transmission resources on the network side.

In some embodiments, although for the AI model, the first part module is deployed in the terminal side and the second part module is deployed in the network side, the essence is still a complete AI model composed of the first part module and the second part module. The first part module in the terminal side and the second part module in the network side complement each other, and the combination of the two is used to achieve terminal positioning. Because during training, the first part module in the terminal side and the second part module in the network side need to be jointly trained, that is, the AI model is obtained in the same training process. The specific training process will not be elaborated in the embodiments of the present disclosure.

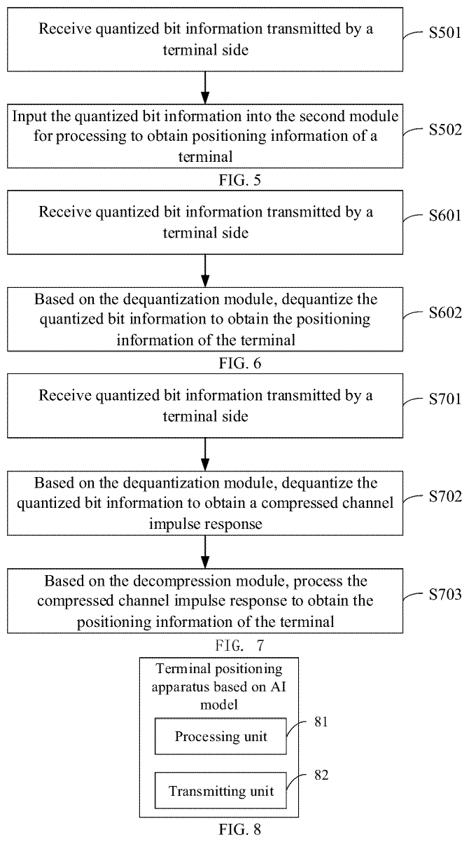

Referring to FIG. 5, FIG. 5 is a flowchart of a terminal positioning method based on an AI model provided in the embodiments of the present disclosure. The method is performed by the network side. As shown in FIG. 5, the method may include but is not limited to the following steps S501 and S502.

In step S501, quantized bit information transmitted by a terminal side is received.

The AI model includes a first part module and a second part module. The first part module is deployed in the terminal side, and the second part module is deployed in the network side. At the terminal side, the channel impulse response is obtained based on the measurement quantity, and then the channel impulse response is inputted to the first part module in the terminal side to obtain quantized bit information. This processing is executed by the terminal side. The quantized bit information transmitted by the first part module in the terminal side is received by the second part module in the network side.

In step S502, the quantized bit information is inputted into the second module for processing to obtain positioning information of a terminal.

The received quantized bit information is inputted into the second part module of the AI model, where the second part module performs the calculation of the positioning information of the terminal.

In some embodiments, the positioning information of the terminal includes but is not limited to positioning coordinates or parameters required by the terminal. The parameter required for the positioning is any one of the following: signal arrival time, signal arrival angle, non-line-of-sight (NLOS) information, or line-of-sight (LOS) information.

After the quantized bit information is transmitted from the first part module of the AI model deployed in the terminal side to the second part module of the AI model in the network side, the second part module in the network side receives the quantized bit information and the positioning information of the terminal can be determined by the dequantization module in the second part module of the AI model. For the terminal positioning, the first part module of the AI model in the terminal side assists the second part module of the AI model in the network side to determine the positioning information of the terminal, which can reduce the input amount of channel impulse response on the network side and thus reduce the occupation of transmission resources on the network side.

The embodiments of the present disclosure provide another terminal positioning method based on an AI model. FIG. 6 is a flowchart of another terminal positioning method based on an AI model provided in the embodiments of the present disclosure. As shown in FIG. 6, the terminal positioning method based on an AI model may include the following steps S601 and S602.

In step S601, quantized bit information transmitted by a terminal side is received.

In step S602, based on the dequantization module, the quantized bit information is dequantized to obtain the positioning information of the terminal.

The received quantized bit information is inputted into the second part module of the AI model, where the second part module includes a dequantization module. the quantized bit information is dequantized by the dequantization module and then the positioning information of the terminal is calculated.

In some embodiments, the positioning information of the terminal includes but is not limited to positioning coordinates or parameters required by the terminal. The parameter required for the positioning is any one of the following: signal arrival time, signal arrival angle, NLOS, or LOS.

After the quantized bit information is transmitted from the first part module of the AI model deployed in the terminal side to the second part module of the AI model in the network side, the second part module in the network side receives the quantized bit information and dequantization is performed by the dequantization module in the second part. Based on the dequantized bit information, the positioning information of the terminal is determined. For the terminal positioning, the first part module of the AI model in the terminal side assists the second part module of the AI model in the network side to determine the positioning information of the terminal, which can reduce the input amount of channel impulse response on the network side and thus reduce the occupation of transmission resources on the network side.

The embodiments of the present disclosure provide another terminal positioning method based on an AI model. FIG. 7 is a flowchart of another terminal positioning method based on an AI model provided in the embodiments of the present disclosure. As shown in FIG. 7, the terminal positioning method based on an AI model may include the following steps S701, S702 and S703.

In step S701, quantized bit information transmitted by a terminal side is received.

In step S702, based on the dequantization module, the quantized bit information is dequantized to obtain a compressed channel impulse response.

At the terminal side, the channel impulse response is obtained based on the measurement quantity, and then the channel impulse response is compressed by the compression module to obtain the compressed channel impulse response. The compressed channel impulse response inputted into the quantization module of the first part module in the terminal side. Based on the quantization module, the inputted compressed channel impulse response is quantized to obtain quantized bit information. This process is executed by the terminal side.

At the network side, the received quantized bit information transmitted by the terminal is inputted into the second part module of the AI model, where the second part module includes a dequantization module and a decompression module. Dequantization is performed by the dequantization module on the quantized bit information to obtain the compressed channel impulse response.

In step S703, based on the decompression module, the compressed channel impulse response is processed to obtain the positioning information of the terminal.

The compressed channel impulse response obtained through processing by the dequantization module is inputted to the decompression module in the second part module to process the compressed channel impulse response to obtain the positioning information of the terminal.

In some embodiments, the positioning information of the terminal includes but is not limited to positioning coordinates or parameters required by the terminal. The parameter required for the positioning is any one of the following: signal arrival time, signal arrival angle, NLOS, or LOS.

After the quantized bit information is transmitted from the first part module of the AI model deployed in the terminal side to the second part module of the AI model in the network side, the second part module in the network side receives the quantized bit information and dequantization is performed by the dequantization module in the second part, to obtain the compressed channel impulse response. The compressed channel impulse response is decompressed by the decompression module and the positioning information of the terminal is determined based on the decompressed bit information. For the terminal positioning, the first part module of the AI model in the terminal side assists the second part module of the AI model in the network side to determine the positioning information of the terminal, which can reduce the input amount of channel impulse response on the network side and thus reduce the occupation of transmission resources on the network side.

In some embodiments, although for the AI model, the first part module is deployed in the terminal side and the second part module is deployed in the network side, the essence is still a complete AI model composed of the first part module and the second part module. The first part module in the terminal side and the second part module in the network side complement each other, and the combination of the two is used to achieve terminal positioning. Because during training, the first part module in the terminal side and the second part module in the network side need to be jointly trained, that is, the AI model is obtained in the same training process. The specific training process will not be elaborated in the embodiments of the present disclosure.

Corresponding to the terminal positioning methods based on an AI model provided in the embodiments of FIGS. 2 to 4, The present disclosure further provides terminal positioning apparatuses based on an AI model. As the terminal positioning apparatuses based on an AI model provided in the present disclosure correspond to the terminal positioning methods based on an AI model provided in the embodiments of FIGS. 2 to 4, the implementation of the terminal positioning methods based on an AI model is also applicable to the terminal positioning apparatuses based on an AI model provided in the present disclosure, and will not be described in detail in the present disclosure.

FIG. 8 is a schematic structural diagram of a terminal positioning apparatus based on an AI model provided in the embodiments of the present disclosure. The apparatus is provided in the terminal side, and the AI model includes a first part module and a second part module. The first part module is deployed in the terminal side, and the apparatus includes a processing unit 81 and a transmitting unit 82.

The processing unit 81 is configured to input a channel impulse response into the first part module for processing, to obtain quantized bit information.

The transmitting unit 82 is configured to transmit the quantized bit information to a network side.

As a possible implementation of the embodiments of the present disclosure, the first part module includes a quantization module, The processing unit 81 is further configured to, based on the quantization module, quantize the inputted channel impulse response to obtain the quantized bit information.

As a possible implementation of the embodiments of the present disclosure, the first part module includes a compression module and a quantization module.

The processing unit is further configured to, based on the compression module, compress the channel impulse response to obtain a compressed channel impulse response; and
based on the quantization module, quantize the compressed channel impulse response to obtain the quantized bit information.

As a possible implementation of the embodiments of the present disclosure, the first and second modules of the AI model are obtained by joint training.

Corresponding to the terminal positioning methods based on an AI model provided in the embodiments of FIGS. 5 to 7, The present disclosure further provides terminal positioning apparatuses based on an AI model. As the terminal positioning apparatuses based on an AI model provided in the present disclosure correspond to the terminal positioning methods based on an AI model provided in the embodiments of FIGS. 5 to 7, the implementation of the terminal positioning methods based on an AI model is also applicable to the terminal positioning apparatuses based on an AI model provided in the present disclosure, and will not be described in detail in the present disclosure.

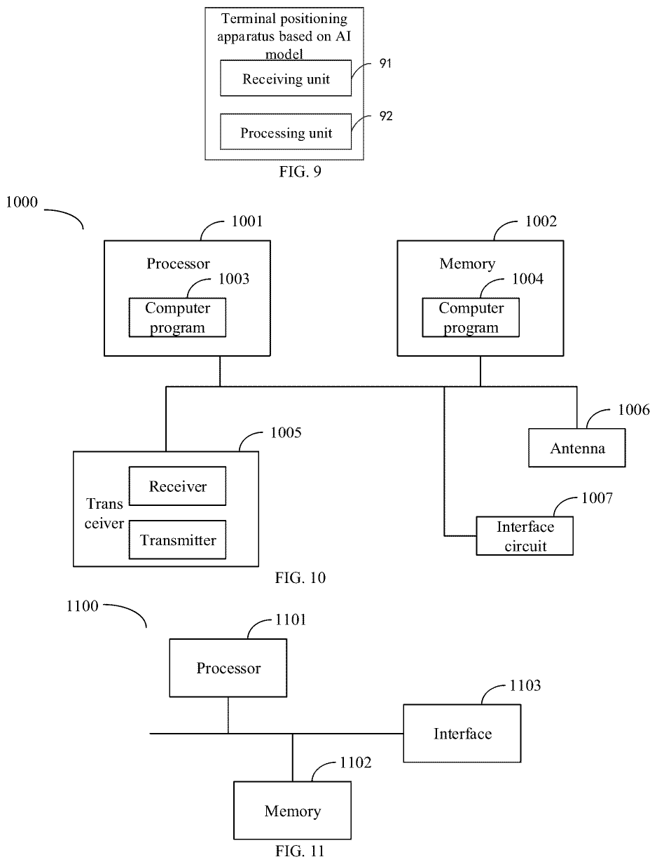

FIG. 9 is a schematic structural diagram of a terminal positioning apparatus based on an AI model provided in the embodiments of the present disclosure. The terminal positioning apparatus based on an AI model is applied to a network side, where the AI model includes a first part module and a second part module, the second part module is deployed in the network side, and the apparatus includes a receiving unit 91 and a processing unit 92.

The receiving unit 91 is configured to receive quantized bit information transmitted by a terminal side.

The processing unit 92 is configured to input the quantized bit information into the second part module for processing to obtain positioning information of a terminal.

As a possible implementation of the embodiments of the present disclosure, the second part module includes a dequantization module, and the processing unit 92 is further configured to dequantize the quantized bit information based on the dequantization module to obtain the positioning information of the terminal.

As a possible implementation of the embodiments of the present disclosure, the second part module includes a dequantization module and a decompression module. The processing unit 92 is further configured to:
based on the dequantization module, dequantize the quantized bit information to obtain a compressed channel impulse response; and
based on the decompression module, process the compressed channel impulse response to obtain the positioning information of the terminal.

As a possible implementation of the embodiments of the present disclosure, the first and second modules of the AI model are obtained by joint training.

As a possible implementation of the embodiments of the present disclosure, the positioning information refers to positioning coordinates or parameters required for positioning.

As a possible implementation of the embodiments of the present disclosure, the parameter required for positioning is any one of the following:
signal arrival time, signal arrival angle, non-line-of-sight (NLOS) information, or line-of-sight (LOS) information.

Referring to FIG. 10, FIG. 10 is a schematic structural diagram of a communication device provided in the embodiments of the present disclosure. In FIG. 10, the communication device 1000 can be a network device, a terminal device, a chip, a chip system, or a processor that supports the embodiment of the above method implemented by a network device, and can also be a chip, a chip system, or a processor that supports the embodiment of the above method implemented by a terminal device. The device can be configured to implement the methods described in the above method embodiments, as described in the above method embodiments.

The communication device 1000 may include one or more processors 1001. The processor 1001 can be a general-purpose processor or a dedicated processor, etc. For example, the processor 1001 can be a baseband processor or a central processing unit. The baseband processor can be used to process communication protocols and communication data, while the central processor can be used to control communication devices (such as base stations, baseband chips, terminal devices, terminal device chips, DU or CU, etc.), execute computer programs, and process computer program data.

In an embodiment, the communication device 1000 may further include one or more memories 1002, on which a computer program 1004 may be stored, and the processor 1001 may execute the computer program 1004 to enable the communication device 1000 to execute the method described in the above embodiments. In an embodiment, the memory 1002 may further store data. The communication device 1000 and memory 1002 can be set separately or integrated together.

In an embodiment, the communication device 1000 may also include a transceiver 1005 and an antenna 1006. The transceiver 1005 can be referred to as a transceiver unit, transceiver machine, or transceiver circuit, etc., used to achieve transceiver functions. The transceiver 1005 can include a receiving terminal and a transmitter, and the receiving terminal can be referred to as a receiving machine or a receiving circuit, etc., to achieve receiving functions. A transmitter can be referred to as a transmitting machine or a transmission circuit, etc., used to achieve transmission functions.

In an embodiment, the communication device 1000 may further include one or more interface circuits 1007. Interface circuit 1007 is configured to receive code instructions and transmit them to processor 1001. The processor 1001 runs the code instructions to cause the communication device 1000 to execute the method described in the above method embodiment.

Communication device 1000 is the first node: transceiver 1005 is used to perform step 201 and other steps in FIG. 2.

Communication device 1000 is a network device: transceiver 1005 is used to perform step 402 and other steps in FIG. 4.

In an embodiment, the processor 1001 may include a transceiver for implementing reception and transmission functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing code/data, or the above-mentioned transceiver circuit, interface or interface circuit can be used for signal transmission or transmission.

In an embodiment, the processor 1001 may store a computer program 1003. The computer program 1003 runs on the processor 1001 to enable the communication device 1000 to execute the method described in the above embodiments. The computer program 1003 may be embedded in processor 1001, where the processor 1001 may be implemented by hardware.

In an embodiment, the communication device 1000 may include a circuit that can perform the functions of transmitting, receiving, or communicating as described in the aforementioned method embodiments. The processor and transceiver described in the present disclosure can be implemented on integrated circuits (ICs), analog ICs, RF integrated circuits (RFICs), mixed signal ICs, application specific integrated circuits (ASICs), printed circuit boards (PCBs), electronic devices, or the like. The processor and transceiver can also be manufactured using various IC process technologies, such as complementary metal oxide semiconductor (CMOS), nMetal oxide semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The communication device described in the above embodiments may be a network device or a terminal device, but the scope of the communication device described in the present disclosure is not limited to this, and the structure of the communication device may not be limited by FIG. 10. The communication device can be an independent device or can be part of a larger device. For example, the communication device may be:
(1) Independent integrated circuit (IC), or a chip, or a chip system or a subsystem;
(2) A set of one or more ICs, which may optically further include a storage component for storing data or a computer program;
(3) ASICs, such as modems;
(4) Modules that can be embedded in other devices;
(5) Receiver, terminal device, intelligent terminal device, cellular phone, wireless device, handheld device, mobile unit, vehicle mounted device, network device, cloud device, or artificial intelligence device, etc;
(6) Others and so on.

In a case where the communication device is a chip or a chip system, it can be referred to the schematic structural diagram of a chip shown in FIG. 11. The chip 1100 shown in FIG. 11 includes a processor 1101 and an interface 1103. The number of processors 1101 can be one or more, and the number of interfaces 1103 can be multiple.

For the case where the chip is configured to implement the functions of the terminal in the embodiments of the present disclosure:
interface 1103 is used to execute step 202 in FIG. 2; step 302 in FIG. 3; step 402 in FIG. 4, etc.

For the case where the chip is configured to implement the functions of the network in the embodiments of the present disclosure:
interface 1103 is used to execute step 501 in FIG. 5, step 601 in FIG. 6, etc.

In some embodiments, the chip 1100 also includes a memory 1102, which is configured to store necessary computer programs and data.

Those skilled in the art can also understand that the various illustrative logical blocks and steps listed in the embodiments of the present disclosure can be implemented through electronic hardware, computer software, or a combination of both. Whether such functionality is implemented through hardware or software depends on the specific application and overall system design requirements. Those skilled in the art may use various methods to implement the described functions for each specific application, but such implementation should not be understood as exceeding the scope of protection in the embodiments of the present disclosure.

The present disclosure further provides a readable storage medium on which instructions are stored, and when the instructions are executed by a computer, the functions of any one of the above method embodiments are implemented.

The present disclosure further provides a computer program product that implements the functions of any one of the above method embodiments when executed by a computer.

The above embodiments can be fully or partially implemented through software, hardware, firmware, or any combination thereof. When implemented using software, all or part of the steps can be implemented in the form of a computer program product. The computer program product includes one or more computer programs. When loading and executing the computer program on the computer, all or part of the processes or functions described in the embodiments of the present disclosure are generated. The computer can be a general-purpose computer, a specialized computer, a computer network, or other programmable devices. The computer program can be stored in a computer-readable storage medium or transmitted from one computer-readable storage medium to another. For example, the computer program can be transmitted from one website site, computer, server, or data center to another via wired (such as coaxial cable, fiber optic, digital subscriber line (DSL)) or wireless (such as infrared, wireless, microwave, etc.) manners. The computer-readable storage medium can be any available medium that the computer can access, or a data storage device such as a server, data center, etc. that integrates one or more available media. The available medium can be a magnetic medium (such as floppy disk, hard disk, magnetic tape), optical medium (such as high-density digital video disc (DVD)), or semiconductor medium (such as solid state disk (SSD)), etc.

Those skilled in the art can understand that the first, second, and other numerical numbers involved in the present disclosure are only for the convenience of description and differentiation, and are not used to limit the scope of the embodiments of the present disclosure, and also do not indicate sequential ordering.

“At least one” in the present disclosure can also be described as one or more, and multiple can be two, three, four, or more, without limitation in the present disclosure. In embodiments of the present disclosure, for a technical feature, the technical features described in “first”, “second”, “third”, “A”, “B”, “C”, and “D” are distinguished, and there is no sequential ordering or magnitude ordering between the technical features described in “first”, “second”, “third”, “A”, “B”, “C”, and “D”.

It can be understood that in the present disclosure, “a plurality of” refers to two or more, similar to other quantifiers. The term “and/or” is only a description of the association relationship of associated objects, indicating that there can be three types of relationships, such as, A and/or B can represent three situations of A alone, A and B simultaneously, and B alone. The character “/” generally indicates that the associated objects before and after “/” are in an “or” relationship. The singular forms “a”, “an” and “the” are intended to include the plural forms as well, unless the context clearly indicates otherwise.

It can be further understood that the meanings of words such as “in response to” and “if” mentioned in the present disclosure depend on the context and the actual usage scenario. For example, the word “is” used here can be interpreted as “when” or “where”.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the corresponding relationships shown in certain rows may not be configured. For example, appropriate deformation adjustments can be made according to the above table, such as splitting, merging, etc. The names of the parameters shown in the titles of the above tables can also use other names that can be understood by the communication device, and the values or representations of their parameters can also be understood by other values or representations that can be understood by the communication device. When implementing the above tables, other data structures can also be used, such as arrays, queues, containers, stacks, linear tables, pointers, linked lists, trees, graphs, structures, classes, heaps, hash tables, or hash tables.

1. A terminal positioning method based on an AI model, performed by a terminal side, wherein the AI model comprises a first part module and a second part module, the first part module is deployed in the terminal side, and the method comprises:
inputting a channel impulse response into the first part module for processing, to obtain quantized bit information; and
transmitting the quantized bit information to a network side.

2. The method according to claim 1, wherein the first part module comprises a quantization module, and inputting the channel impulse response into the first part module for processing, to obtain the quantized bit information comprises:
based on the quantization module, quantizing the inputted channel impulse response to obtain the quantized bit information.

3. The method according to claim 1, wherein the first part module comprises a compression module and a quantization module, and inputting the channel impulse response into the first part module for processing, to obtain the quantized bit information comprises:
based on the compression module, compressing the channel impulse response to obtain a compressed channel impulse response; and
based on the quantization module, quantizing the compressed channel impulse response to obtain the quantized bit information.

4. The method according to claim 1, wherein the first part module and the second part module in the AI model are obtained by joint training.

5. A terminal positioning method based on an AI model, performed by a network side, wherein the AI model comprises a first part module and a second part module, the second part module is deployed in the network side, and the method comprises:
receiving quantized bit information transmitted by a terminal side; and
inputting the quantized bit information into the second part module for processing to obtain positioning information of a terminal.

6. The method according to claim 5, wherein the second part module comprises a dequantization module, and inputting the quantized bit information into the second part module for processing to obtain the positioning information of the terminal comprises:
based on the dequantization module, dequantizing the quantized bit information to obtain the positioning information of the terminal.

7. The method according to claim 5, wherein the second part module comprises a dequantization module and a decompression module, and inputting the quantized bit information into the second part module for processing to obtain the positioning information of the terminal comprises:
based on the dequantization module, dequantizing the quantized bit information to obtain a compressed channel impulse response; and
based on the decompression module, processing the compressed channel impulse response to obtain the positioning information of the terminal.

8. The method according to claim 5, wherein the first part module and the second part module in the AI model are obtained by joint training.

9. The method according to claim 8, wherein the positioning information is positioning coordinates or a parameter required for positioning.

10. The method according to claim 9, wherein the parameter required for positioning comprises:
signal arrival time, signal arrival angle, non-line-of-sight (NLOS) information, or line-of-sight (LOS) information.

11.-20. (canceled)

21. A communication device, comprising one or more processors and one or more memories, wherein a computer program is stored in the one or more memories, and the one or more processors execute the computer program stored in the one or more memories to cause the communication device to perform the method according to claim 1.

22. A non-transitory computer-readable storage medium storing instructions, wherein the instructions are executed, to implement the method according to claim 1.

23. A communication device, comprising one or more processors and one or more memories, wherein a computer program is stored in the one or more memories, and the one or more processors execute the computer program stored in the one or more memories to cause the communication device to perform the method according to claim 5.

24. A non-transitory computer-readable storage medium storing instructions, wherein the instructions are executed, to implement the method according to claim 5.
